(19) United States
(12) Patent Application Publication
(10) Pub. No.: US 2026/0235734 A1
(43) Pub. Date: Aug. 13, 2026

(54) LASER MEASUREMENT METHOD, LIDAR, AND AUTONOMOUS VEHICLE

(71) Applicant: BEIJING MORELITE SEMICONDUCTOR CO., LTD., Beijing (CN)

(72) Inventors: Xunbao RUI, Beijing (CN); Dongquan ZHANG, Beijing (CN); Tianbo SUN, Beijing (CN); Jie SUN, Beijing (CN); Rui QI, Beijing (CN)

(21) Appl. No.: 19/435,548

(22) Filed: Dec. 29, 2025

(30) Foreign Application Priority Data
Feb. 10, 2025 (CN) 202510147537.9

(51) Int. Cl. G01S 7/484; G01S 7/481; G01S 7/4861

(52) U.S. Cl. CPC G01S 7/484; G01S 7/4814; G01S 7/4816; G01S 7/4861

(57) ABSTRACT

A laser measurement method and a lidar are provided. The laser measurement method includes: performing upper sideband modulation on a first laser beam to obtain an up-modulation signal; performing lower sideband modulation on the first laser beam to obtain a down-modulation signal; generating a combined beam including the up-modulation signal and the down-modulation signal; generating and emitting a signal beam, wherein the signal beam carries part or all of the combined beam including the up-modulation signal and the down-modulation signal; receiving a reflected beam generated by reflection of a signal beam when encountering a target object; obtaining the beat frequency in the frequency-up phase and the beat frequency in the frequency-down phase between a second laser beam and the reflected beam; detecting the beat frequencies in the frequency-up phase and in the frequency-down phase between the second laser beam and the reflected beam.

### CROSS-REFERENCE TO RELATED APPLICATION

This application claims a priority to Chinese Patent Application No. 202510147537.9 filed on Feb. 10, 2025, the disclosures of which are incorporated in their entirety by reference herein.

### TECHNICAL FIELD

The present application relates to the field of lidar measurement, and in particular, to a laser measurement method applied to lidar, a lidar, and an autonomous vehicle including the lidar.

### BACKGROUND

A Frequency Modulated Continuous Wave (FMCW) lidar emits a laser beam and uses a detector to receive the reflected beam from a target object in the surrounding environment, thereby calculating information such as the distance and speed of the target object. Due to the Doppler shift and the lidar system itself, to accurately obtain the speed signal and distance signal of the target object at a certain moment, it is necessary to have both frequency-up phase information and frequency-down phase information. The related FMCW lidar uses an optical coherent device to obtain the beat frequency in the frequency-up phase and the beat frequency in the frequency-down phase respectively, which cannot solve the ranging blind zone caused by the Doppler shift and is not conducive to improving the angular resolution of the lidar.

### SUMMARY

To solve the problems in the related art of being unable to avoid measurement blind zones and being unfavorable for improving the angular resolution of lidar, the present application provides the following technical solutions.

In a first aspect, the present application provides a laser measurement method applied to lidar. The method includes: performing upper sideband modulation on a first laser beam to obtain an up-modulation signal; performing lower sideband modulation on the first laser beam to obtain a down-modulation signal; generating a combined beam including the up-modulation signal and the down-modulation signal; generating and emitting a signal beam, wherein the signal beam carries part or all of the combined beam including the up-modulation signal and the down-modulation signal; receiving a reflected beam generated by the reflection of the signal beam when encountering a target object; obtaining the beat frequency in the frequency-up phase and the beat frequency in the frequency-down phase between a second laser beam and the reflected beam; and detecting the beat frequency in the frequency-up phase and the beat frequency in the frequency-down phase between the second laser beam and the reflected beam to measure the speed of the object and/or the distance between the object and the lidar.

Optionally, performing upper sideband modulation on the first laser beam and performing lower sideband modulation on the first laser beam includes: using a Mach-Zehnder modulator to perform carrier-suppressed upper sideband modulation and lower sideband modulation on the first laser beam.

Optionally, obtaining the beat frequency in the frequency-up phase and the beat frequency in the frequency-down phase between the second laser beam and the reflected beam includes: simultaneously obtaining the beat frequency in the frequency-up phase and the beat frequency in the frequency-down phase between the second laser beam and the reflected beam at the same moment.

Optionally, the beat frequency in the frequency-up phase and the beat frequency in the frequency-down phase are symmetrically distributed on both sides of the Doppler shift generated by the relative speed between the object and the lidar.

Optionally, before performing upper sideband modulation on the first laser beam and performing lower sideband modulation on the first laser beam, the method further includes: obtaining the first laser beam from a laser light source, wherein the first laser beam has a single wavelength; wherein generating the signal beam includes: splitting the combined beam using an optical splitter to obtain the signal beam and the second laser beam.

Optionally, obtaining the beat frequency in the frequency-up phase and the beat frequency in the frequency-down phase between the second laser beam and the reflected beam includes: performing in-phase quadrature coherent demodulation on the second laser beam and the reflected beam to obtain the beat frequency in the frequency-up phase and the beat frequency in the frequency-down phase between the second laser beam and the reflected beam.

Optionally, before performing upper sideband modulation on the first laser beam and performing lower sideband modulation on the first laser beam, the method further includes: obtaining a laser beam from a laser light source; splitting the laser beam to obtain the first laser beam and the second laser beam, wherein the laser beam, the first laser beam, and the second laser beam have the same modulation waveform, and the signal beam carries all of the combined beam.

Optionally, obtaining the beat frequency in the frequency-up phase and the beat frequency in the frequency-down phase between the second laser beam and the reflected beam includes: performing in-phase quadrature optical mixing on the second laser beam and the reflected beam to obtain an in-phase intermediate frequency signal and a quadrature intermediate frequency signal; performing first electrical mixing on the in-phase intermediate frequency signal and a frequency-swept intermediate frequency signal, and performing second electrical mixing on the quadrature intermediate frequency signal and the frequency-swept intermediate frequency signal to obtain the beat frequency in the frequency-up phase and the beat frequency in the frequency-down phase between the second laser beam and the reflected beam.

In a second aspect, the present application provides a lidar. The lidar includes: a Mach-Zehnder modulator configured to perform upper sideband modulation on a first laser beam to obtain an up-modulation signal; perform lower sideband modulation on the first laser beam to obtain a down-modulation signal; and generate a combined beam including the up-modulation signal and the down-modulation signal; an optical transceiver configured to generate and emit a signal beam and receive a reflected beam generated by the reflection of the signal beam when encountering an object, wherein the signal beam carries part or all of the combined beam including the up-modulation signal and the down-modulation signal; a beat frequency acquirer configured to obtain the beat frequency in the frequency-up phase and the beat frequency in the frequency-down phase between a second laser beam and the reflected beam; and a detector configured to detect the beat frequency in the frequency-up phase and the beat frequency in the frequency-down phase between the second laser beam and the reflected beam to measure the speed of the object and/or the distance between the object and the lidar.

Optionally, the lidar includes: a first optical splitter configured to split the combined beam to generate the signal beam and the second laser beam; or a second optical splitter configured to obtain a laser beam from a laser source and split the laser beam into the first laser beam and the second laser beam.

The solutions of the present application have the following beneficial effects:

By adopting the lidar and the laser measurement method of the present application, the scalar values (true values) of the beat frequency in the frequency-up phase and the beat frequency in the frequency-down phase can be accurately obtained, the measurement frequency spectrum of the lidar can be expanded, and the ranging blind zone caused by the Doppler shift can be avoided. In addition, double-sideband inverse modulation enables obtaining the beat frequency information in the frequency-up phase and the frequency-down phase at the same moment (Fast Fourier Transform FFT time window), which can improve the angular resolution of the radar, increase the detection success rate, obtain the speed direction of the target, and solve the problem of point cloud trailing. Furthermore, compared with the dual-modulation FMCW lidar system using two lasers, the double-sideband inverse modulation method of the present application uses a single laser, and the modulations in the frequency-up phase and the frequency-down phase have the same phase noise. The same phase noise can be suppressed through data processing at the receiving end, thereby improving the signal-to-noise ratio of the received signal.

### BRIEF DESCRIPTION OF THE DRAWINGS

FIG. 1 shows a schematic diagram of the working principle of a related frequency-modulated continuous wave lidar;

FIG. 2 shows a schematic diagram of measuring a target object to obtain the beat frequency in the frequency-up phase and the beat frequency in the frequency-down phase using a related technology;

FIG. 3 shows a schematic diagram where the beat frequency in the frequency-up phase and the beat frequency in the frequency-down phase are outside the measurement frequency spectrum of the lidar due to the Doppler shift;

FIG. 4 shows a schematic diagram of obtaining the scalar values of the beat frequency in the frequency-up phase and the beat frequency in the frequency-down phase by using the in-phase IQ coherent demodulation method of the present application;

FIG. 5 shows a schematic flowchart of the laser measurement method of the present application;

FIG. 6A shows a first schematic diagram of a waveform modulated by the Mach-Zehnder modulator of the present application;

FIG. 6B shows a second schematic diagram of a waveform modulated by the Mach-Zehnder modulator of the present application;

FIG. 6C shows a third schematic diagram of a waveform modulated by the Mach-Zehnder modulator of the present application;

FIG. 6D shows a fourth schematic diagram of a waveform modulated by the Mach-Zehnder modulator of the present application;

FIG. 7 shows a schematic diagram of a frequency spectrum modulated by the Mach-Zehnder modulator of the present application;

FIG. 8 shows a schematic diagram of simultaneously obtaining the beat frequency in the frequency-up phase and the beat frequency in the frequency-down phase by using the laser measurement method of the present application;

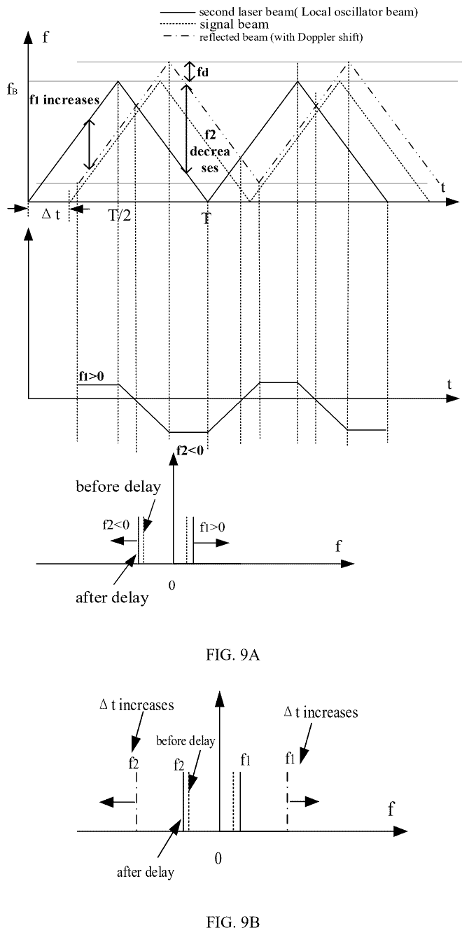

FIGS. 9A and 9B show schematic diagrams of time-delaying the signal beam and the reflected beam in the solution of the present application;

FIGS. 10A and 10B show time-frequency domain schematic diagrams of time-delaying the local oscillator beam by using the laser measurement method of the present application;

FIG. 11 shows a schematic diagram of frequency-shifting the local oscillator beam by using the laser measurement method of the present application;

FIG. 12 shows a schematic diagram of frequency-shifting the signal beam by using the laser measurement method of the present application;

FIG. 13 shows a schematic diagram of expanding the measurement frequency spectrum of the lidar by using the laser measurement method of the present application;

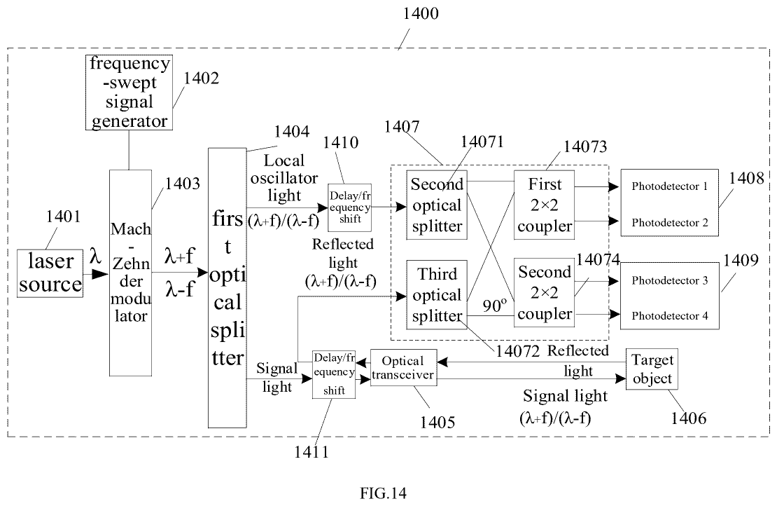

FIG. 14 shows a first schematic diagram of the structure of the lidar of the present application;

FIG. 15 shows a second schematic diagram of the structure of the lidar of the present application; and

FIGS. 16A and 16B show schematic diagrams of an autonomous vehicle including the lidar of the present application.

### DETAILED DESCRIPTION

Hereinafter, specific implementations of the present application will be described in detail with reference to the accompanying drawings. When the following description refers to the accompanying drawings, the same numbers in different accompanying drawings represent the same or similar elements unless otherwise indicated. In the following exemplary embodiments, the described implementations are not all implementations of the present application. On the contrary, they are only examples of devices and methods consistent with some aspects of the present application as detailed in the appended claims. The embodiments in the present application and the features in the embodiments can be combined with each other without conflict.

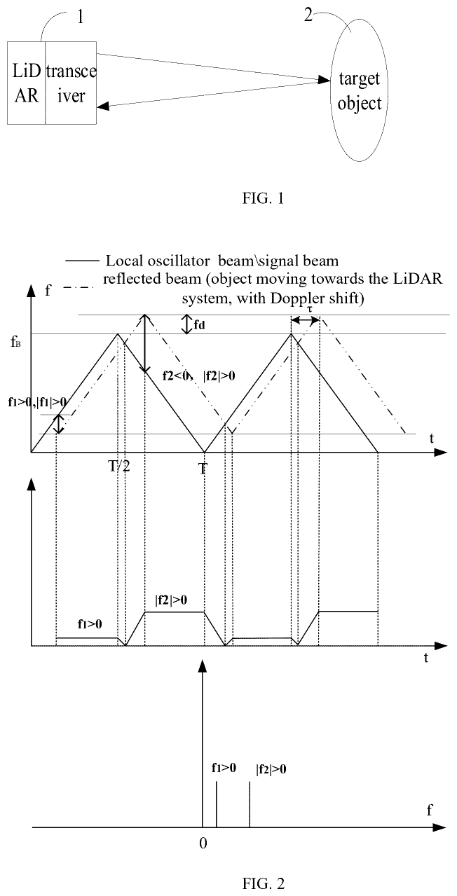

Referring to FIG. 1, FIG. 1 is a schematic diagram of the working principle of a related Frequency Modulated Continuous Wave (FMCW) lidar. The related FMCW lidar 1 adopts the working principle of coherent reception. By comparing the instantaneous frequency relationship between the reflected beam reflected from the target object 2 and the local oscillator beam of the lidar 1, information such as the distance between the target object 2 and the lidar 1 and the speed of the target object can be obtained simultaneously. The related FMCW lidar can use a periodic triangular wave or sawtooth wave waveform as the signal beam.

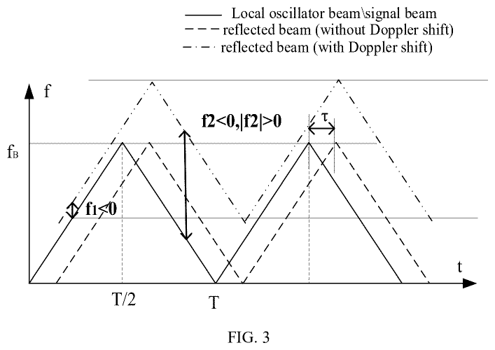

Referring to FIG. 2, FIG. 2 shows a schematic diagram of measuring a target object to obtain the beat frequency in the frequency-up phase and the beat frequency in the frequency-down phase using a related technology. In FIG. 2, the solid triangular wave is the instantaneous time-frequency relationship of the signal beam or local oscillator beam of the lidar, and the dashed triangular wave is the instantaneous real-frequency relationship of the reflected beam of the target object, where t is the delay of the reflected beam of the target object, f1 and f2 are the beat frequencies of the reflected beam of the target object in the up-sweep part and the down-sweep part (i.e., the beat frequency in the frequency-up phase and the beat frequency in the frequency-down phase between the reflected beam and the local oscillator beam), Tis the period including one up-sweep stage and one down-sweep stage, fB is the sweep bandwidth of the linear frequency modulation, and fd=(f2−f1)/2. In FIG. 2, the beat frequency in the frequency-up phase and the beat frequency in the frequency-down phase of the reflected beam are respectively:

$${f}_{1} = \frac{2 {f}_{B}}{T} \cdot \frac{2 R}{c} - \frac{2 v}{λ} \qquad [ Formula 1 ]$$

$${f}_{2} = \frac{2 {f}_{B}}{T} \cdot \frac{2 R}{c} + \frac{2 v}{λ}$$

Assuming the distance between the target object and the lidar is R, then R=τ*c/2, where c is the speed of light and λ is the laser wavelength. Then, in the time-frequency relationship diagram of FIG. 2, the distance R and speed v of the target object are as follows:

$$\{ \begin{matrix}R = \frac{( {f}_{1} + {f}_{2} ) \cdot T \cdot c}{8 {f}_{B}} \\ v = \frac{( {f}_{2} - {f}_{1} ) \cdot λ}{4}\end{matrix} \qquad [ Formula 2 ]$$

When f1=0, the above relationship between distance and speed can be expressed as follows:

$${R}_{m} = \frac{v \times T \times c}{2 \times λ \times {f}_{B}} \qquad [ Formula 3 ]$$

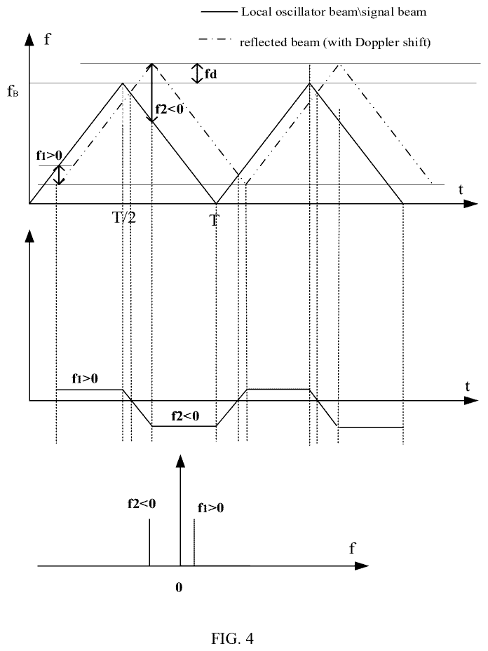

In the above Formula 2, it is required to use the absolute values of f₁ and f₂, that is, both f₁ and f₂ are required to be greater than 0. The actual distance between the lidar and the target object needs to be greater than the R value Rm calculated by the above formula. That is to say, a value smaller than the above Rm will lead to errors in the calculation of speed and distance. In addition, it can be seen from Formula 3 that R is proportional to the speed v of the target object. The greater the speed v of the target object, the greater the above R value. When the real speed v of the target object is fast, the frequency shift caused by the Doppler effect may be greater than the frequency shift caused by the flight time of the reflected beam, resulting in the actual value of the beat frequency f₁ in the frequency-up phase between the local oscillator beam and the received reflected beam being negative, as shown in FIG. 3. Although the actual beat frequency f₁ in the frequency-up phase between the local oscillator beam and the received reflected beam is negative (less than 0), the lidar judges the frequency f₁ as positive (greater than 0). Therefore, when the above Formulas 1-3 are used to calculate the distance and speed of the target object, errors will occur in the calculation of distance and speed, resulting in a measurement blind zone.

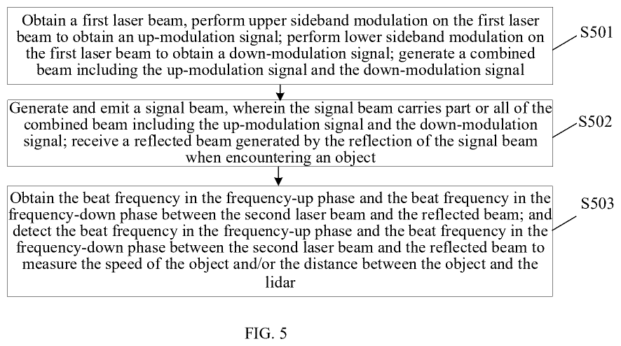

In some embodiments, the present application adopts an In-phase Quadrature (IQ) coherent demodulation method to obtain the true values, i.e., scalar values (positive or negative values, i.e., values greater than 0 or less than 0), of the beat frequency in the frequency-up phase and the beat frequency in the frequency-down phase between the reflected beam and the local oscillator beam, as shown in FIG. 4. The solution of the present application can obtain the true values instead of the absolute values (only values greater than 0) of the beat frequency in the frequency-up phase and the beat frequency in the frequency-down phase, which can effectively avoid the ranging blind zone. Since negative frequency information is obtained, the solution of the present application can also increase the width of the ranging frequency spectrum of the lidar.

Specifically, when the scalar values of the beat frequency in the frequency-up phase and the beat frequency in the frequency-down phase are obtained by using the in-phase IQ coherent demodulation method of the present application, the calculation method adopted is also different from the above Formulas 1-2. When the target object moves towards the lidar, the frequency of the reflected beam increases relative to the frequency of the local oscillator beam. At this time, the beat frequency in the frequency-up phase and the beat frequency in the frequency-down phase of the reflected beam are respectively:

$${f}_{1} = \frac{2 {f}_{B}}{T} \cdot \frac{2 R}{c} - \frac{2 v}{λ} \qquad [ Formula 4 ]$$

$${f}_{2} = - \frac{2 {f}_{B}}{T} \cdot \frac{2 R}{c} - \frac{2 v}{λ}$$

The distance and speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} ) \cdot λ}{4}\end{matrix} \qquad [ Formula 5 ]$$

When the target object moves away from the lidar, the frequency of the reflected beam decreases relative to the frequency of the local oscillator beam. At this time, the beat frequency in the frequency-up phase and the beat frequency in the frequency-down phase of the reflected beam are respectively:

$${f}_{1} = \frac{2 {f}_{B}}{T} \cdot \frac{2 R}{c} + \frac{2 v}{λ} \qquad [ Formula 6 ]$$

$${f}_{2} = - \frac{2 {f}_{B}}{T} \cdot \frac{2 R}{c} + \frac{2 v}{λ}$$

The distance and speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} ) \cdot λ}{4}\end{matrix} \qquad [ Formula 7 ]$$

By using the above Formulas 4-7, the scalar values (true values) of the beat frequency in the frequency-up phase and the beat frequency in the frequency-down phase can be accurately obtained, the measurement frequency spectrum of the lidar can be expanded, and the ranging blind zone caused by the Doppler shift can be avoided.

The above FMCW lidar uses a single laser wavelength and measures the distance and speed of the target object by using a triangular wave or sawtooth wave frequency sweeping method. One beat frequency in the frequency-up phase and one beat frequency in the frequency-down phase can be obtained within one frequency sweeping period, and it is impossible to obtain the beat frequency in the frequency-up phase and the beat frequency in the frequency-down phase at the same moment. In addition, due to the horizontal scanning of the light beam, there will be many trailing points in the system output point cloud, and the horizontal angular resolution depends on the product of the modulation period and the scanning speed. The related triangular wave or sawtooth wave frequency sweeping method is not conducive to improving the horizontal angular resolution of the radar. Double-sideband inverse modulation enables obtaining the beat frequency information in the frequency-up phase and the frequency-down phase at the same moment (Fast Fourier Transform FFT time window), which can improve the angular resolution of the radar, increase the detection success rate, obtain the speed direction of the target, and solve the problem of point cloud trailing. Furthermore, compared with the dual-modulation FMCW lidar system using two lasers, the double-sideband inverse modulation method of the present application uses a single laser, and the modulations in the frequency-up phase and the frequency-down phase have the same phase noise. The same phase noise can be suppressed through data processing at the receiving end, thereby improving the signal-to-noise ratio of the received signal.

The specific embodiments of the present application are described below.

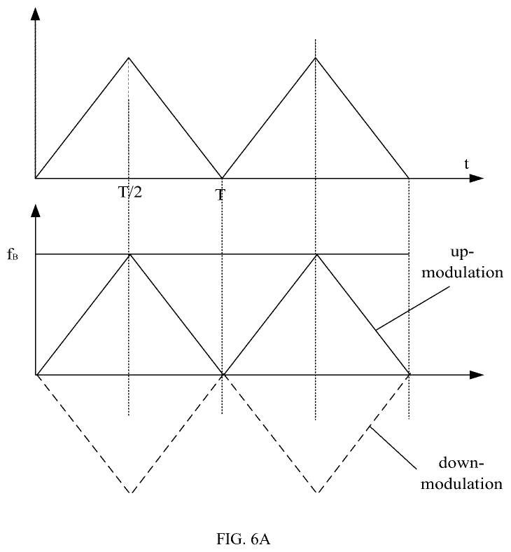

In some embodiments, the present disclosure provides a laser measurement method. The laser measurement method can be applied to a Frequency Modulated Continuous Wave (FMCW) lidar. As shown in FIG. 5, the laser measurement method includes the following steps S501-S503.

Step S501: Obtain a first laser beam, perform upper sideband modulation on the first laser beam to obtain an up-modulation signal; perform lower sideband modulation on the first laser beam to obtain a down-modulation signal; generate a combined beam including the up-modulation signal and the down-modulation signal.

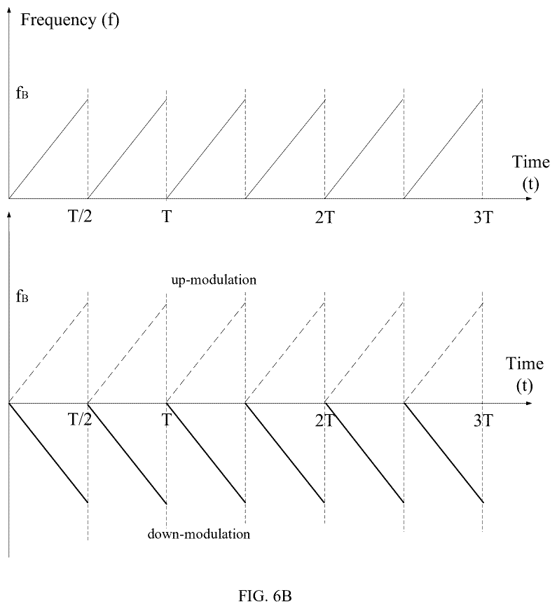

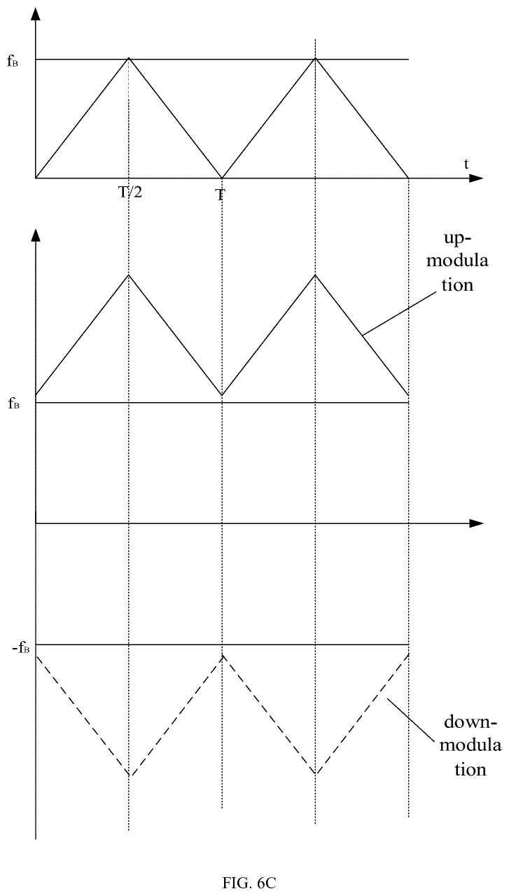

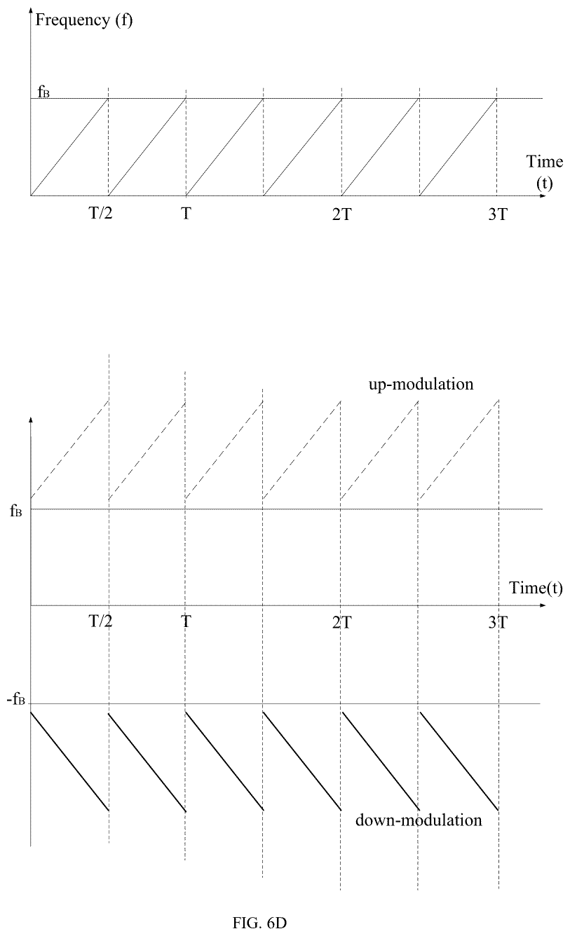

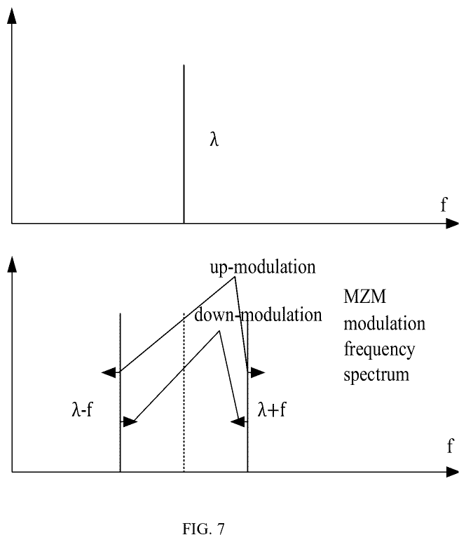

Specifically, in some embodiments, the first laser beam can be generated by a laser light source, and the wavelength of the first laser beam is a single wavelength 2. The first laser beam can be input to the input end of a Mach-Zehnder (MZM) modulator. The Mach-Zehnder modulator performs carrier-suppressed double-sideband modulation, i.e., upper sideband modulation and lower sideband modulation, on the first laser beam under the control of a frequency-swept signal input by a frequency-swept signal generator. The frequency-swept signal generator can generate a frequency-swept signal with a preset waveform, which can be a triangular wave frequency-swept signal or a sawtooth wave frequency-swept signal. A triangular wave frequency-swept signal is shown in FIG. 6A, and a sawtooth wave frequency-swept signal is shown in FIG. 6B.

The Mach-Zehnder (MZM) modulator uses the principle of light interference to change the phase of the optical signal by adjusting the input voltage of the phase modulator (frequency-swept signal generator), thereby realizing the modulation of the optical signal. The Mach-Zehnder modulator is composed of two optical splitters and two phase modulators. The optical splitter is used to split the input optical signal into two beams, and the phase modulator is used to control the phase of the optical signal. The optical signal is first split into two light rays by the first optical splitter. The two light rays pass through the two phase modulators respectively. By adjusting the input voltage of the phase modulator, the phases of the two light rays can be changed. The two light rays after phase modulation are combined again in the second optical splitter. Due to the phase change of the two light rays, they will produce an interference effect. By adjusting the input voltage of the phase modulator, the phase difference between the two light rays can be changed, thereby changing the interference effect. In this way, the amplitude and phase of the optical signal can be modulated. The specific structure of the Mach-Zehnder modulator can be referred to the description of the related art, which is not described in detail in the present application.

As shown in FIG. 6, the frequency-swept signal modulated by the MZM modulator is a double-sideband inverse modulated frequency-swept signal. Within one frequency-sweeping period T, peaks and troughs appear simultaneously. The peaks and troughs are inverted modulated signals, and the maximum value of the peaks is the same as the minimum value of the troughs. Therefore, the frequency of the upper sideband modulation is a positive value, and the frequency of the lower sideband modulation is a negative value. The upper sideband modulated signal and the lower sideband modulated signal can be judged by the position of the frequency spectrum.

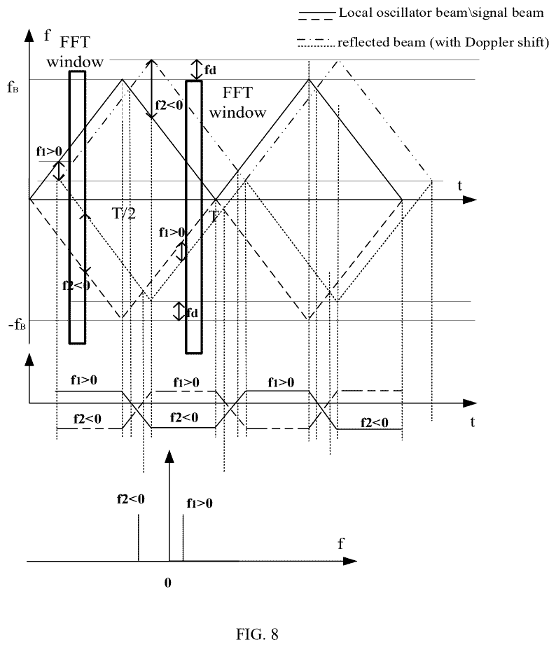

In other embodiments, a laser beam with a single wavelength can be generated by a laser light source. The laser beam is input to a fourth optical splitter, which splits the laser beam into a first laser beam and a second laser beam, wherein the laser beam, the first laser beam, and the second laser beam have the same modulation waveform (e.g., the same wavelength λ). The first laser beam can be input to the input end of a Mach-Zehnder (MZM) modulator. The MZM modulator performs carrier-suppressed double-sideband modulation on the first laser beam, and the signal after double-sideband modulation includes both the up-modulation frequency λ+f and the down-modulation frequency λ−f. The dual-wavelength light beam after double-sideband modulation forms a combined beam, as shown in FIG. 7.

Step S502: Generate and emit a signal beam, wherein the signal beam carries part or all of the combined beam including the up-modulation signal and the down-modulation signal; receive a reflected beam generated by the reflection of the signal beam when encountering an object.

Specifically, in some embodiments, the combined beam output by the MZM modulator, which includes the up-modulation signal and the down-modulation signal, can be split by a first optical splitter to generate a signal beam and a local oscillator beam with the same frequency. The signal beam can be emitted through an optical transceiver. The signal beam carries a part of the combined beam.

Optionally, before emitting the signal beam, the signal beam can be delayed or frequency-shifted.

Specifically, a time delay device can be used to shift the waveform of the signal beam. The number of time delay devices can be one or more (e.g., multiple series-connected time delay devices, such as delay optical fibers) to delay the signal beam in time. The parameters of the time delay device can be limited according to the performance of the lidar system and the maximum moving speed of the target object.

In other embodiments, the combined beam output by the MZM modulator, which includes the up-modulation signal and the down-modulation signal, is directly emitted as signal light through an optical transceiver. The signal beam carries all of the combined beam.

In some examples, the optical transceiver is used to emit the signal beam at a predetermined angle, and an optical receiver or the optical transceiver is used to receive the reflected light reflected by the target object. Optionally, a polarization splitter (e.g., polarization splitter-rotator (PSR)), a circulator (e.g., three-port circulator), a lens assembly, a beam scanning guiding device, etc., may be included between the optical transceiver and the target object. The lens assembly is configured to collimate the signal beam and focus the reflected beam to couple into the optical transceiver. The beam scanning guiding device is configured to realize the deflection and scanning of light.

Step S503: Obtain the beat frequency in the frequency-up phase and the beat frequency in the frequency-down phase between the second laser beam and the reflected beam; and detect the beat frequency in the frequency-up phase and the beat frequency in the frequency-down phase between the second laser beam and the reflected beam to measure the speed of the object and/or the distance between the object and the lidar.

Specifically, in some embodiments, the reflected light can be input to a 90-degree mixer. The 90-degree mixer also receives a second laser beam, which can be a local oscillator beam generated by splitting the combined beam carrying the up-modulation signal and the down-modulation signal by the first optical splitter. By using the 90-degree mixer, in-phase quadrature coherent demodulation can be performed on the second laser beam and the reflected beam, and the beat frequency in the frequency-up phase and the beat frequency in the frequency-down phase between the second laser beam and the reflected beam can be obtained. The beat frequency in the frequency-up phase and the beat frequency in the frequency-down phase can include negative frequencies. That is to say, the scalar values (positive or negative values, i.e., values greater than 0 or less than 0) of the beat frequency in the frequency-up phase and the beat frequency in the frequency-down phase can be obtained through the 90-degree mixer. The relative phase differences of the four output ports of the 90-degree mixer are 0°, 90°, 180°, and 270° respectively. The 90-degree mixer can be a 90-degree mixing unit known to those skilled in the art. It is not described in detail in the present application.

The mixed signal can be input to a first balanced detector and a second balanced detector for detection. The first balanced detector and the second balanced detector can be photodetectors. For the related knowledge of detecting the mixed signal by the balanced detector, reference can be made to related documents, which is not described in detail in the present application.

Optionally, before inputting the second laser beam to the 90-degree mixer, the second laser beam is delayed or frequency-shifted; and/or before emitting the signal beam, the signal beam can be delayed or frequency-shifted. By means of delay or frequency shift, the frequency values of the beat frequency in the frequency-up phase or the beat frequency in the frequency-down phase can be changed, so that the beat frequency moves to the left or right along the frequency axis. Changing the positions of the beat frequency in the frequency-up phase and the beat frequency in the frequency-down phase between the second laser beam and the reflected beam on the measurement frequency spectrum of the lidar can correctly calculate the speed of the target object and the distance and speed between the lidar and the target object, avoid measurement blind zones, and improve measurement accuracy.

In some embodiments, time-delaying at least one of the signal beam, the reflected beam, and the second laser beam (i.e., the local oscillator beam) includes: time-delaying the signal beam and the reflected beam, or time-delaying the local oscillator beam, so that the beat frequency in the frequency-up phase and the beat frequency in the frequency-down phase between the local oscillator beam and the reflected beam move to the first direction or the second direction of the ranging frequency spectrum of the lidar. The first direction of the ranging frequency spectrum is the direction in which the beat frequency in the frequency-up phase and the beat frequency in the frequency-down phase gradually increase, such as the direction to the right of the frequency axis. The second direction of the ranging frequency spectrum is the direction in which the beat frequency in the frequency-up phase and the beat frequency in the frequency-down phase gradually decrease, such as the direction to the left of the frequency axis. Therefore, by time-delaying at least one of the signal beam, the reflected beam, and the local oscillator beam, the scalar values of the beat frequency in the frequency-up phase and the beat frequency in the frequency-down phase can be increased or decreased.

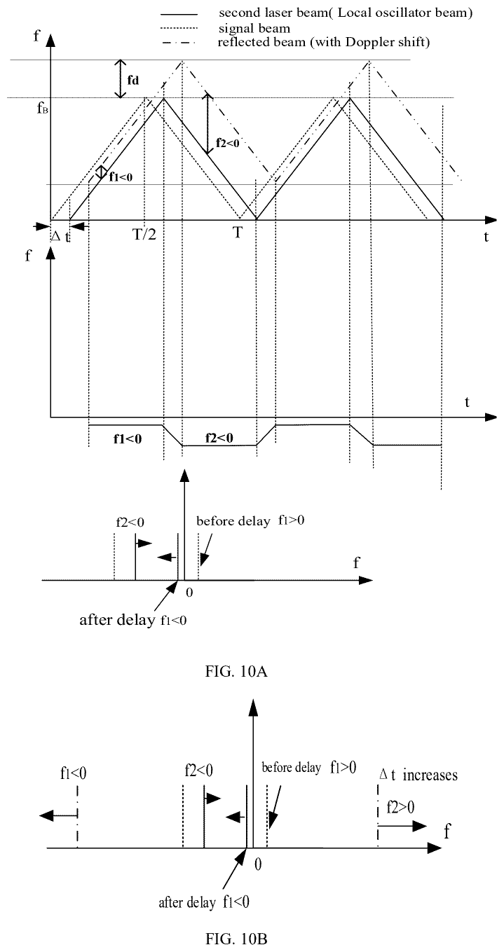

Taking the triangular wave of the first laser beam as an example, as shown in FIG. 9A, when both the signal beam and the reflected beam are time-delayed by Δt, and the target object moves away from the lidar, the beat frequency in the frequency-up phase and the beat frequency in the frequency-down phase of the reflected beam are respectively:

$${f}_{1} = \frac{2 {f}_{B}}{T} \cdot ( \frac{2 R}{c} + Δ t ) + \frac{2 v}{λ} \qquad [ Formula 8 ]$$

$${f}_{2} = - \frac{2 {f}_{B}}{T} \cdot ( \frac{2 R}{c} + Δ t ) + \frac{2 v}{λ}$$

The distance and speed of the target object are as follows:

$$\{ \begin{matrix}R = [ \frac{( {f}_{1} - {f}_{2} ) \cdot T \cdot }{8 {f}_{B}} - \frac{1}{2} Δ t ] \times c \\ v = \frac{( {f}_{2} + {f}_{1} ) \cdot λ}{4}\end{matrix} \qquad [ Formula 9 ]$$

When the target object moves towards the lidar, the frequency of the reflected beam increases relative to the frequency of the local oscillator beam. At this time, the beat frequency in the frequency-up phase and the beat frequency in the frequency-down phase of the reflected beam are respectively:

$${f}_{1} = \frac{2 {f}_{B}}{T} \cdot ( \frac{2 R}{c} + Δ t ) - \frac{2 v}{λ} \qquad [ Formula 10 ]$$

$${f}_{2} = - \frac{2 {f}_{B}}{T} \cdot ( \frac{2 R}{c} + Δ t ) - \frac{2 v}{λ}$$

The distance and speed of the target object are as follows:

$$\{ \begin{matrix}R = [ \frac{( {f}_{1} - {f}_{2} ) \cdot T \cdot }{8 {f}_{B}} - \frac{1}{2} Δ t ] \times c \\ v = - \frac{( {f}_{2} + {f}_{1} ) \cdot λ}{4}\end{matrix} \qquad [ Formula 11 ]$$

As shown in FIG. 9B, when Δt increases, the beat frequency f1 in the frequency-up phase and the beat frequency f2 in the frequency-down phase between the local oscillator beam and the reflected beam move in opposite directions, thereby increasing the distance between them. On the contrary, when Δt decreases, the beat frequency f1 in the frequency-up phase and the beat frequency f2 in the frequency-down phase between the local oscillator beam and the reflected beam move towards each other, thereby decreasing the distance between them. When Δt continues to decrease, the beat frequency f1 in the frequency-up phase and the beat frequency f2 in the frequency-down phase can cross each other and move in opposite directions, thereby increasing the distance between them.

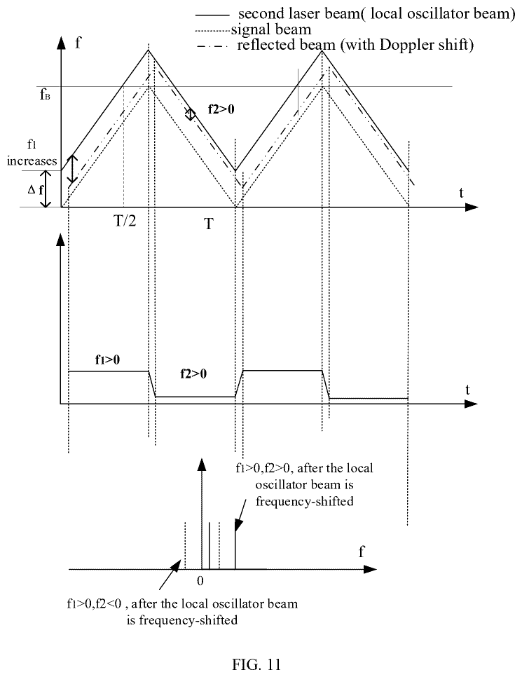

Taking the triangular wave signal of the first laser beam as an example, as shown in FIG. 10A, in this embodiment, the local oscillator signal is time-delayed by Δt. When the target object moves away from the lidar, the beat frequency in the frequency-up phase and the beat frequency in the frequency-down phase of the reflected beam are respectively:

$${f}_{1} = \frac{2 {f}_{B}}{T} \cdot ( \frac{2 R}{c} - Δ t ) + \frac{2 v}{λ} \qquad [ Formula 12 ]$$

$${f}_{2} = - \frac{2 {f}_{B}}{T} \cdot ( \frac{2 R}{c} - Δ t ) + \frac{2 v}{λ}$$

The distance and speed of the target object are as follows:

$$\{ \begin{matrix}R = [ \frac{( {f}_{1} - {f}_{2} ) \cdot T \cdot }{8 {f}_{B}} + \frac{1}{2} Δ t ] \times c \\ v = \frac{( {f}_{2} + {f}_{1} ) \cdot λ}{4}\end{matrix} \qquad [ Formula 13 ]$$

When the target object moves towards the lidar, the frequency of the reflected beam increases relative to the frequency of the local oscillator beam. At this time, the beat frequency in the frequency-up phase and the beat frequency in the frequency-down phase of the reflected beam are respectively:

$${f}_{1} = \frac{2 {f}_{B}}{T} \cdot ( \frac{2 R}{c} - Δ t ) - \frac{2 v}{λ} \qquad [ Formula 14 ]$$

$${f}_{2} = - \frac{2 {f}_{B}}{T} \cdot ( \frac{2 R}{c} - Δ t ) - \frac{2 v}{λ}$$

The distance and speed of the target object are as follows:

$$\{ \begin{matrix}R = [ \frac{( {f}_{1} - {f}_{2} ) \cdot T \cdot }{8 {f}_{B}} + \frac{1}{2} Δ t ] \times c \\ v = - \frac{( {f}_{2} + {f}_{1} ) \cdot λ}{4}\end{matrix} \qquad [ Formula 15 ]$$

As shown in FIG. 10B, when Δt increases, the beat frequency f1 in the frequency-up phase and the beat frequency f2 in the frequency-down phase between the local oscillator beam and the reflected beam move towards each other, thereby decreasing the distance between them. When Δt continues to increase, the beat frequency f1 in the frequency-up phase and the beat frequency f2 in the frequency-down phase can cross each other and move in opposite directions, thereby increasing the distance between them. On the contrary, when Δt decreases, the beat frequency f1 in the frequency-up phase and the beat frequency f2 in the frequency-down phase between the local oscillator beam and the reflected beam move in opposite directions, thereby increasing the distance between them.

In the above embodiments, both the signal beam and the reflected beam can be time-delayed, and/or the local oscillator beam can be time-delayed. By time-delaying one or more of the signal beam, the reflected beam, and the local oscillator beam, the positions of the beat frequency f1 in the frequency-up phase and the beat frequency f2 in the frequency-down phase between the local oscillator beam and the reflected beam on the measurement frequency spectrum of the lidar can be changed. The speed of the target object and the distance and speed between the lidar and the target object can be correctly calculated according to the above formulas, avoiding measurement blind zones and improving measurement accuracy. In addition, due to the adoption of time delay, the time delay system can be used as the measurement scale of the lidar measurement system to accurately obtain the position of the measurement zero point.

Optionally, in some embodiments, at least one of the signal beam, the reflected beam, and the local oscillator beam can be frequency-shifted. Specifically, the frequency of the signal beam or the local oscillator beam can be frequency-shifted, so that the beat frequency in the frequency-up phase and the beat frequency in the frequency-down phase between the local oscillator beam and the reflected beam are shifted to the first direction or the second direction of the measurement frequency spectrum.

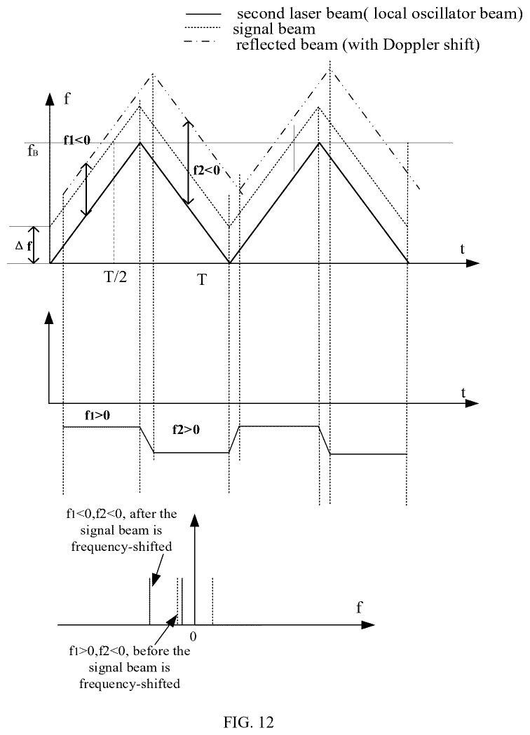

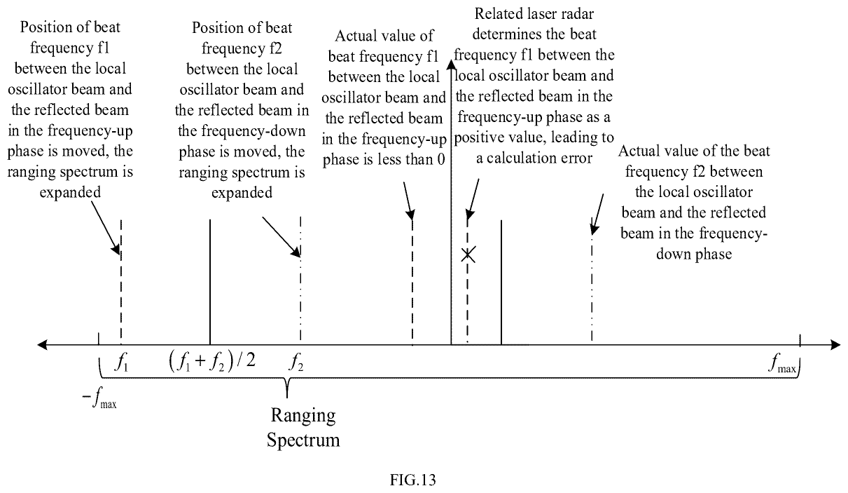

The first direction of the ranging frequency spectrum is the direction in which the beat frequency in the frequency-up phase and the beat frequency in the frequency-down phase gradually increase, such as the direction to the right of the frequency axis in FIGS. 11 and 12. The second direction of the ranging frequency spectrum is the direction in which the beat frequency in the frequency-up phase and the beat frequency in the frequency-down phase gradually decrease, such as the direction to the left of the frequency axis in FIGS. 11 and 12. Therefore, by time-delaying at least one of the signal beam, the reflected beam, and the local oscillator beam, the scalar values of the beat frequency in the frequency-up phase and the beat frequency in the frequency-down phase can be increased or decreased.

In some embodiments, when the frequency of the local oscillator beam is frequency-shifted, the entire frequency of the local oscillator beam can be increased or decreased. Taking the triangular wave of the first laser beam as an example, as shown in FIG. 11, the entire frequency of the local oscillator beam is increased by Δf. When the target object moves away from the lidar, the beat frequency in the frequency-up phase and the beat frequency in the frequency-down phase are respectively:

$${f}_{1} = \frac{2 {f}_{B}}{T} \cdot \frac{2 R}{c} + \frac{2 v}{λ} + Δ f \qquad [ Formula 16 ]$$

$${f}_{2} = - \frac{2 {f}_{B}}{T} \cdot \frac{2 R}{c} + \frac{2 v}{λ} + Δ f$$

The distance and speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} - 2 Δ f ) \cdot λ}{4}\end{matrix} \qquad [ Formula 17 ]$$

When the target object moves towards the lidar, the beat frequency in the frequency-up phase and the beat frequency in the frequency-down phase are respectively:

$${f}_{1} = \frac{2 {f}_{B}}{T} \cdot \frac{2 R}{c} - \frac{2 v}{λ} + Δ f \qquad [ Formula 18 ]$$

$${f}_{2} = - \frac{2 {f}_{B}}{T} \cdot \frac{2 R}{c} - \frac{2 v}{λ} + Δ f$$

The distance and speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} - 2 Δ f ) \cdot λ}{4}\end{matrix} \qquad [ Formula 19 ]$$

In some embodiments, when the frequency of the signal beam is frequency-shifted, the entire frequency of the signal can be increased or decreased. For example, as shown in FIG. 12, the entire frequency of the signal beam is increased by Δf. When the target object moves away from the lidar, the beat frequency in the frequency-up phase and the beat frequency in the frequency-down phase are respectively:

$${f}_{1} = \frac{2 {f}_{B}}{T} \cdot \frac{2 R}{c} + \frac{2 v}{λ} - Δ f \qquad [ Formula 20 ]$$

$${f}_{2} = - \frac{2 {f}_{B}}{T} \cdot \frac{2 R}{c} + \frac{2 v}{λ} - Δ f$$

The distance and speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} + 2 Δ f ) \cdot λ}{4}\end{matrix} \qquad [ Formula 21 ]$$

When the target object moves towards the lidar, the beat frequency in the frequency-up phase and the beat frequency in the frequency-down phase are respectively:

$${f}_{1} = \frac{2 {f}_{B}}{T} \cdot \frac{2 R}{c} - \frac{2 v}{λ} - Δ f \qquad [ Formula 22 ]$$

$${f}_{2} = - \frac{2 {f}_{B}}{T} \cdot \frac{2 R}{c} - \frac{2 v}{λ} - Δ f$$

The distance and speed of the target object are as follows:

$$\{ \begin{matrix}R = \frac{( {f}_{1} - {f}_{2} ) \cdot T \cdot c}{8 {f}_{B}} \\ v = \frac{( - {f}_{2} - {f}_{1} - 2 Δ f ) \cdot λ}{4}\end{matrix} \qquad [ Formula 23 ]$$

In some embodiments, the minimum value of the scalar values of the beat frequency in the frequency-up phase and the beat frequency in the frequency-down phase is equal to the maximum negative frequency shift caused by the Doppler effect.

In some embodiments of the present application, the start time of the triangular wave waveform of the second laser beam is half a period different from the start time of the triangular wave of the first laser beam. The above calculation methods for the beat frequency in the frequency-up phase and the beat frequency in the frequency-down phase of the triangular wave waveform of the first laser beam, as well as the distance and speed of the target object, are also applicable to the beat frequency in the frequency-up phase and the beat frequency in the frequency-down phase of the triangular wave of the second laser beam. For details, refer to the above description, which is not repeated in the present application.

By frequency-shifting the local oscillator beam, the signal beam, or the reflected beam, the positions of the beat frequency in the frequency-up phase and the beat frequency in the frequency-down phase on the measurement frequency spectrum of the lidar system can be changed. Combined with the in-phase quadrature coherent demodulation method of the present application, the range of the measurement frequency spectrum of the lidar system can be expanded from [0, ∞) to [−∞, +∞], thereby avoiding measurement blind zones.

Optionally, in other embodiments, the reflected light and the second laser beam generated by the fourth optical splitter can be input to an IQ optical mixer. The IQ optical mixer multiplies the reflected beam and the second laser beam to convert the frequency of the optical signal into a desired intermediate frequency signal. During the conversion process, the frequency of the input signal undergoes mirror transformation. After conversion to the intermediate frequency range, subsequent signal processing and demodulation can be performed with an electrical mixer. I in the IQ optical mixer represents the real part, and Q represents the imaginary part. By processing I and Q respectively, the positive and negative frequencies of the frequency spectrum can be obtained, thereby forming a symmetric frequency spectrum structure. The reflected beam is generated by irradiating the target object with the combined beam generated by the MZM modulator. Therefore, there is a frequency-swept frequency (intermediate frequency) generated by the frequency-swept signal generator between the reflected beam and the second laser beam. The IQ optical mixer can output an I-branch signal and a Q-branch signal. The I-branch signal and the Q-branch signal are input to the first electrical mixer and the second electrical mixer respectively. The first electrical mixer and the second electrical mixer also obtain the frequency-swept frequency from the frequency-swept signal generator. By adding or subtracting the frequency of the frequency-swept signal of the triangular wave (intermediate frequency) to/from the I-branch signal, the beat frequency in the frequency-up phase and the beat frequency in the frequency-down phase can be obtained.

In the embodiments of the present application, the optical splitter may specifically be a specific wavelength coupler (optical splitter) for wavelengths of 445~2100 nm, such as a 1×2 optical splitter on an optical chip and an SMC series optical splitter. In other examples, other optical splitters known to those skilled in the art that can split the frequency-swept beam into a signal beam and a local oscillator beam may also be used.

Optionally, in some embodiments, the starting frequencies of the up-modulation signal and the down-modulation signal output by the Mach-Zehnder modulator can be increased by Δf. Thereby, the mutual mixing noise of the up-modulation signal and the down-modulation signal that may be introduced during simultaneous demodulation is eliminated. Optionally, Δf is higher than the detection bandwidth f_{B}, so that the noise is in the high-frequency part outside the detection bandwidth, thereby eliminating the mutual mixing noise, as shown in FIGS. 6C and 6D.

In some embodiments, the present application also discloses an FMCW lidar.

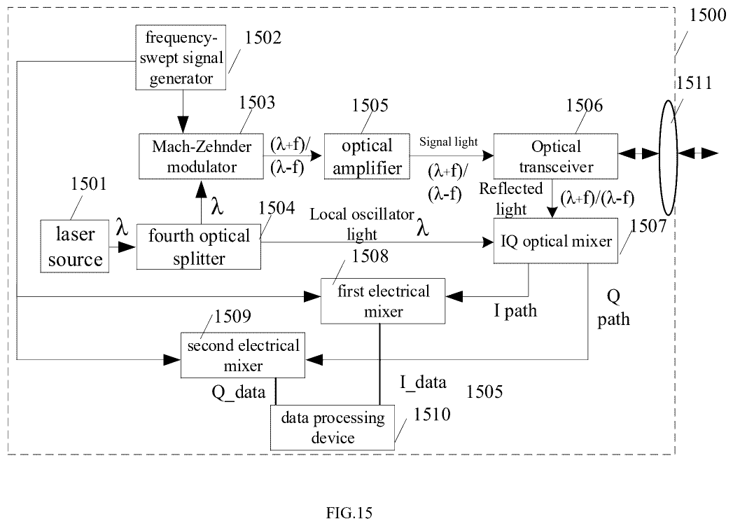

Referring to FIG. 14, in some embodiments, the FMCW lidar of the present application includes a laser source 1401, a frequency-swept signal generator 1402, a Mach-Zehnder modulator 1403, a first optical splitter 1404, an optical transceiver 1405, an in-phase quadrature coherent demodulator 1407, a first balanced detector 1408, and a second balanced detector 1409.

The laser 1401 is configured to generate a first laser beam with a wavelength of λ. The first laser beam is input to the input end of the Mach-Zehnder modulator 1403. The Mach-Zehnder modulator 1403 also receives a frequency-swept control signal from the frequency-swept signal generator 1402, and generates an up-modulation signal and a down-modulation signal under the control of the frequency-swept control signal. The wavelength of the up-modulation signal is λ+f, and the wavelength of the down-modulation signal is λ−f. The up-modulation signal and the down-modulation signal together form a combined beam and are input to the first optical splitter 1404. The first optical splitter 1404 is configured to split the combined beam into a local oscillator beam (i.e., the second laser beam) and a signal beam. Each of the local oscillator beam and the signal beam includes two frequencies: wavelength λ+f and wavelength λ−f. The optical transceiver 1405 is configured to emit the signal beam to the target object 1406 and receive the reflected beam reflected by the target object 1406. Optionally, a polarization splitter (e.g., polarization splitter-rotator (PSR)), a circulator (e.g., three-port circulator), a lens assembly, a beam scanning guiding device, etc., may be included between the optical transceiver 1405 and the target object 1406. The lens assembly is configured to collimate the signal beam and focus the reflected beam to couple into the optical transceiver 1405. The beam scanning guiding device is configured to realize the deflection and scanning of light.

Optionally, further, the lidar 1400 further includes a first time delay device or a first frequency shifter 1410 and a second time delay device or a second frequency shifter 1411.

The first time delay device or the first frequency shifter 1410 is disposed between the first optical splitter 1404 and the second optical splitter 14071. The first time delay device 1410 is configured to time-delay the local oscillator beam, and the first frequency shifter 1410 is configured to frequency-shift the local oscillator beam. The second time delay device or the second frequency shifter 1411 is disposed between the first optical splitter 1404 and the third optical splitter 14072. The second time delay device 1411 is configured to time-delay the signal beam and the reflected beam, and the second frequency shifter 1411 is configured to frequency-shift the signal beam and the reflected beam.

Through time delay and/or frequency shift, the beat frequency in the frequency-up phase and the beat frequency in the frequency-down phase between the local oscillator beam and the reflected beam can be shifted to the positive or negative direction of the measurement frequency spectrum, thereby expanding the range of the measurement frequency spectrum, avoiding the measurement blind zone caused by the beat frequency in the frequency-up phase and the beat frequency in the frequency-down phase between the local oscillator beam and the reflected beam being outside the measurement frequency spectrum range of the lidar, and improving the measurement accuracy. For the principle of moving the beat frequency in the frequency-up phase and the beat frequency in the frequency-down phase through time delay and/or frequency shift, refer to the relevant description above in the present application, which is not repeated here to avoid redundancy.

In some embodiments, the in-phase quadrature coherent demodulator 1407 may be a 90-degree mixing unit, which specifically includes: a second optical splitter 14071, a third optical splitter 14072, a first 2×2 coupler 14073, and a second 2×2 coupler 14074. Wherein, the second optical splitter 14071 is configured to receive the local oscillator beam from the first optical splitter 14042. The local oscillator beam is split into two beams, which are input to the first 2×2 coupler 14073 and the second 2×2 coupler 14074 respectively. The third optical splitter 14072 is configured to receive the reflected beam from the optical transceiver 1405. The reflected beam is split into two beams, which are input to the first 2×2 coupler 14073 and the second 2×2 coupler 14074 respectively. The first 2×2 coupler 14073 is configured to couple the two beams from the second optical splitter 14071 and the third optical splitter 14072 into two beams with phases of 0° and 180° respectively, and input the two beams to the first balanced detector 1408 through the first output port and the second output port. The second 2×2 coupler 14074 is configured to couple the two beams from the second optical splitter 14071 and the third optical splitter 14072 into two beams with phases of 90° and 270° respectively, and input the two beams to the second balanced detector 1409 through the third output port and the fourth output port.

The first balanced detector 1408 includes a photodetector 1 and a photodetector 2, which are connected in series. The photodetector 1 is configured to receive the output light of 0°, and the photodetector 2 is configured to receive the output light of 180°. The second balanced detector 1409 includes a photodetector 3 and a photodetector 4. The photodetector 3 and the photodetector 4 are connected in series. The photodetector 3 is configured to receive the output light of 90°, and the photodetector 4 is configured to receive the output light of 270°. Wherein, the DC components of the photocurrents obtained by the balanced detector from the beams of 0° and 180° as well as 90° and 270° are respectively equal.

The lidar shown in FIG. 14 of the present application can obtain the scalar values of the beat frequencies in the frequency-up phase and the frequency-down phase of the local oscillator signal and the reflected signal, expand the measurement frequency spectrum range of the lidar, avoid the measurement blind zone caused by the Doppler shift, and improve the measurement accuracy. In addition, the device adopts a Mach-Zehnder modulator to realize double-sideband inverse modulation on a single laser, and can obtain the beat frequency in the frequency-up phase and the beat frequency in the frequency-down phase at the same sampling moment, which can accurately obtain the speed and distance information of the target object, improve the angular scanning accuracy of the laser, solve the problem that the beat frequency in the frequency-up phase and the beat frequency in the frequency-down phase cannot be distinguished due to Doppler broadening, obtain the direction of the target speed, improve the signal-to-noise ratio of the signal, and solve the problems of point cloud trailing and poor angular accuracy of single-sideband modulation. In addition, the Mach-Zehnder modulator is used to realize double-sideband inverse modulation, and the phase noises of the upper-modulated and lower-modulated laser signals are consistent. The phase noises of the upper-modulated and lower-modulated signals can be canceled out through data processing at the receiving end, thereby improving the detection signal-to-noise ratio. In addition, the double-sideband inverse triangular wave external modulation adopts a long modulation period, which avoids the instability of the modulation frequency caused by short-period modulation and improves the ranging accuracy.

The lidar can implement the method steps described above. For the relevant content of the lidar, refer to the relevant description of the method embodiment above. It is not repeated here.

Referring to FIG. 14, FIG. 14 shows another embodiment of the lidar of the present application. The lidar may be an FMCW lidar. The lidar includes a laser source 1501, a frequency-swept signal generator 1502, a Mach-Zehnder modulator 1503, a fourth optical splitter 1504, an optical amplifier 1505, an optical transceiver 1506, an IQ optical mixer 1507, a first electrical mixer 1508, a second electrical mixer 1509, and a data processing device 1510.

The laser source 1501 is configured to generate a laser beam with a wavelength of λ. The fourth optical splitter 1504 is configured to split the laser beam into a first laser beam and a second laser beam. The first laser beam and the second laser beam have the same wavelength λ. The frequency-swept signal generator 1502 is configured to generate a frequency-swept signal with a preset waveform, such as a triangular wave frequency-swept signal or a sawtooth wave frequency-swept signal. The Mach-Zehnder modulator 1503 is configured to receive the first laser beam and perform carrier-suppressed double-sideband modulation on the first laser beam under the control of the frequency-swept signal generator 1502 to generate a combined beam having an up-modulation signal and a down-modulation signal. The wavelength of the up-modulation signal is λ+f, and the wavelength of the down-modulation signal is λ−f.

The optical amplifier 1505 is configured to amplify the combined beam and provide the amplified light as a signal beam to the optical transceiver 1506. The optical transceiver 1506 is configured to emit the signal beam at a predetermined angle and receive the reflected light reflected by the target object.

Optionally, a polarization splitter (e.g., polarization splitter-rotator (PSR)), a circulator (e.g., three-port circulator), a lens assembly, a beam scanning guiding device 1511, etc., may be included between the optical transceiver 1506 and the target object. The lens assembly 1511 is configured to collimate the signal beam and focus the reflected beam to couple into the optical transceiver 1506. The beam scanning guiding device is configured to realize the deflection and scanning of light.

The IQ optical mixer 1507 is configured to receive the second laser beam and the reflected beam, and perform IQ optical mixing on the second laser beam and the reflected beam. Specifically, the IQ optical mixer multiplies the optical signal of the second laser beam and the optical signal of the reflected beam to obtain an in-phase intermediate frequency signal and a quadrature intermediate frequency signal in the intermediate frequency range.

The first electrical mixer 1508 is configured to receive the intermediate frequency signal of the frequency-swept signal generator and the in-phase intermediate frequency signal, perform electrical mixing in the intermediate frequency band on the two signals, and obtain a new mixed signal I_data. The second electrical mixer 1509 is configured to receive the intermediate frequency signal of the frequency-swept signal generator and the quadrature intermediate frequency signal, perform electrical mixing in the intermediate frequency band on the two signals, and obtain a new mixed signal Q_data. The data processing device 1510 is configured to simultaneously obtain the beat frequency signal in the frequency-up phase and the beat frequency signal in the frequency-down phase by performing data processing on Data (Data=I_data+ixQ_data). The beat frequency in the frequency-up phase and the beat frequency in the frequency-down phase are symmetrically distributed on both sides of the Doppler shift generated by the relative speed between the object and the lidar.

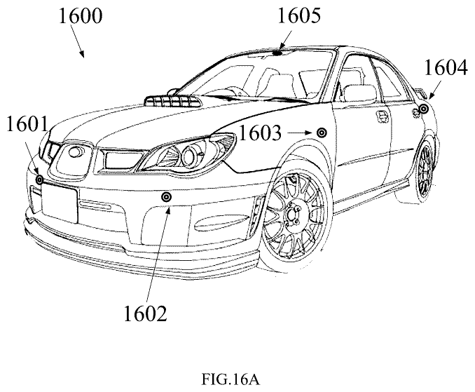

The lidar shown in FIG. 15 of the present application can obtain the scalar values of the beat frequencies in the frequency-up phase and the frequency-down phase of the local oscillator signal and the reflected signal, expand the measurement frequency spectrum range of the lidar, avoid the measurement blind zone caused by the Doppler shift, and improve the measurement accuracy. In addition, the device adopts a Mach-Zehnder modulator to realize double-sideband inverse modulation on a single laser, and can obtain the beat frequency in the frequency-up phase and the beat frequency in the frequency-down phase at the same sampling moment, which can accurately obtain the speed and distance information of the target object, improve the angular scanning accuracy of the laser, solve the problem that the beat frequency in the frequency-up phase and the beat frequency in the frequency-down phase cannot be distinguished due to Doppler broadening, obtain the direction of the target speed, improve the signal-to-noise ratio of the signal, and solve the problems of point cloud trailing and poor angular accuracy of single-sideband modulation. In addition, the Mach-Zehnder modulator is used to realize double-sideband inverse modulation, and the phase noises of the upper-modulated and lower-modulated laser signals are consistent. The phase noises of the upper-modulated and lower-modulated signals can be canceled out through data processing at the receiving end, thereby improving the detection signal-to-noise ratio. In addition, the double-sideband inverse triangular wave external modulation adopts a long modulation period, which avoids the instability of the modulation frequency caused by short-period modulation and improves the ranging accuracy.

The lidar can implement the method steps described above. For the relevant content of the lidar, refer to the relevant description of the method embodiment above. It is not repeated here.

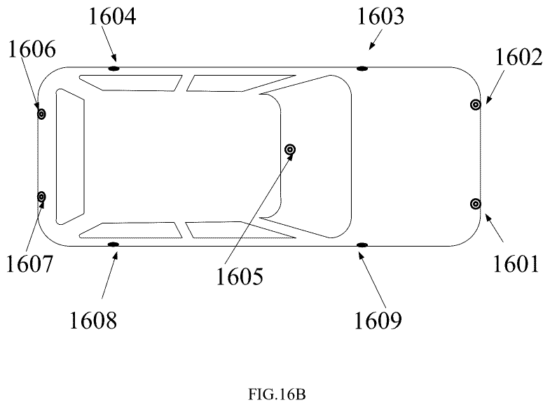

FIGS. 16A and 16B illustrate an exemplary autonomous vehicle 1600 according to an embodiment of the present application, which may include any of the components of the lidar device shown in FIGS. 14-15 of the present application. The illustrated autonomous vehicle 1600 includes a sensor array configured to capture one or more objects in the external environment of the autonomous vehicle and generate sensor data related to the captured one or more objects for controlling the operation of the autonomous vehicle 1600. FIG. 16A shows sensors 1601, 1602, 1603, 1604, and 1605. FIG. 16B illustrates sensors 1601, 1602, 1603, 1604, 1605, 1606, 1607, 1608, and 1609. FIG. 16B shows a top view of the autonomous vehicle 1600. Any one of the sensors 1601, 1602, 1603, 1604, 1605, 1606, 1607, 1608, and 1609 may include the lidar device shown in FIGS. 14-15 of the present application, which includes any LIDAR component of the present application. The autonomous vehicle may include a powertrain including a prime mover powered by an energy source and capable of providing power to a transmission system. The autonomous vehicle may also include a control system including direction control, powertrain control, and brake control. The autonomous vehicle may be implemented as any number of different vehicles, including vehicles capable of transporting people and/or goods and capable of traveling in a variety of different environments. It should be understood that the above components can vary widely based on the type of vehicle utilizing these components.

For the detailed content of this embodiment of the present application, reference may be made to the description of the foregoing method embodiment. To avoid repetition, it is not repeated here.

The above descriptions are only specific implementations of the present application, but the protection scope of the present application is not limited thereto. Any person skilled in the art can easily think of changes or substitutions within the technical scope disclosed in the present application, which should be covered in the protection scope of the present application. Therefore, the protection scope of the present application should be based on the protection scope of the claims.

What is claimed is:

1. A laser measurement method applied to lidar, comprising:
performing upper sideband modulation on a first laser beam to obtain an up-modulation signal; performing lower sideband modulation on the first laser beam to obtain a down-modulation signal;
generating a combined beam including the up-modulation signal and the down-modulation signal;
generating and emitting a signal beam, wherein the signal beam carries part or all of the combined beam including the up-modulation signal and the down-modulation signal;
receiving a reflected beam generated by a reflection of the signal beam when encountering a target object;
obtaining a beat frequency in a frequency-up phase and a beat frequency in a frequency-down phase between a second laser beam and the reflected beam; and
detecting the beat frequency in the frequency-up phase and the beat frequency in the frequency-down phase between the second laser beam and the reflected beam to measure a speed of the target object and/or a distance between the target object and the lidar.

2. The laser measurement method according to claim 1, wherein performing the upper sideband modulation on the first laser beam and performing the lower sideband modulation on the first laser beam comprises:
using a Mach-Zehnder modulator to perform carrier-suppressed upper sideband modulation and lower sideband modulation on the first laser beam.

3. The laser measurement method according to claim 1, wherein obtaining the beat frequency in the frequency-up phase and the beat frequency in the frequency-down phase between the second laser beam and the reflected beam comprises:
simultaneously obtaining the beat frequency in the frequency-up phase and the beat frequency in the frequency-down phase between the second laser beam and the reflected beam at the same moment.

4. The laser measurement method according to claim 1, wherein the beat frequency in the frequency-up phase and the beat frequency in the frequency-down phase are symmetrically distributed on both sides of Doppler shift generated by a relative speed between the target object and the lidar.

5. The laser measurement method according to claim 1, wherein before performing the upper sideband modulation on the first laser beam and performing the lower sideband modulation on the first laser beam, the method further comprises:
obtaining the first laser beam from a laser light source, wherein the first laser beam has a single wavelength;
wherein generating the signal beam comprises:
splitting the combined beam using an optical splitter to obtain the signal beam and the second laser beam.

6. The laser measurement method according to claim 5, wherein obtaining the beat frequency in the frequency-up phase and the beat frequency in the frequency-down phase between the second laser beam and the reflected beam comprises:
performing in-phase quadrature coherent demodulation on the second laser beam and the reflected beam to obtain the beat frequency in the frequency-up phase and the beat frequency in the frequency-down phase between the second laser beam and the reflected beam.

7. The laser measurement method according to claim 1, wherein before performing the upper sideband modulation on the first laser beam and performing the lower sideband modulation on the first laser beam, the method further comprises:
obtaining the laser beam from the laser light source;
splitting the laser beam to obtain the first laser beam and the second laser beam,
wherein the laser beam, the first laser beam, and the second laser beam have the same modulation waveform, and the signal beam carries all of the combined beam.

8. The laser measurement method according to claim 7, wherein obtaining the beat frequency in the frequency-up phase and the beat frequency in the frequency-down phase between the second laser beam and the reflected beam comprises:
performing in-phase quadrature optical mixing on the second laser beam and the reflected beam to obtain an in-phase intermediate frequency signal and a quadrature intermediate frequency signal;
performing first electrical mixing on the in-phase intermediate frequency signal and a frequency-swept intermediate frequency signal, and performing second electrical mixing on the quadrature intermediate frequency signal and the frequency-swept intermediate frequency signal to obtain the beat frequency in the frequency-up phase and the beat frequency in the frequency-down phase between the second laser beam and the reflected beam.

9. A Light Detection and Ranging (lidar) device, comprising:
a Mach-Zehnder modulator configured to perform an upper sideband modulation on a first laser beam to obtain an up-modulation signal; perform lower sideband modulation on the first laser beam to obtain a down-modulation signal; and generate a combined beam including the up-modulation signal and the down-modulation signal;
an optical transceiver configured to generate and emit a signal beam and receive a reflected beam generated by a reflection of the signal beam when encountering a target object, wherein the signal beam carries part or all of the combined beam including the up-modulation signal and the down-modulation signal;
a beat frequency acquirer configured to obtain the beat frequency in the frequency-up phase and the beat frequency in the frequency-down phase between a second laser beam and the reflected beam; and
a detector configured to detect the beat frequency in the frequency-up phase and the beat frequency in the frequency-down phase between the second laser beam and the reflected beam to measure the speed of the target object and/or the distance between the target object and the lidar.

10. The lidar device according to claim 9, comprising:
a first optical splitter configured to split the combined beam to generate the signal beam and the second laser beam; or
a second optical splitter configured to obtain a laser beam from a laser source and split the laser beam into the first laser beam and the second laser beam.
